(19) United States
(12) Patent Application Publication
(10) Pub. No.: US 2007/0185421 A1
(43) Pub. Date: Aug. 9, 2007

(54) Folding bed message mattress with idler wheel

(76) Inventor: Dong-Her Wu, Chang Hua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/346,350

(22) Filed: Feb. 3, 2006

(51) Int. Cl. A61H 15/00

(52) U.S. Cl. 601/102; 601/116; 601/99; 601/98; 601/101

(57) ABSTRACT

A folding full bed massage mattress with idler wheel, which is comprised by two half covered bed mattresses and connected with top section of each mattress into full bed so that it can be folded; its features are as follows: an independent motor-driven active shaft lever is respectively mounted in inner middle section of this two groups of half bed mattresses, each carry one group to mount on shaft lever, passive massage seat with idler wheel that can move to and fro in axial direction is installed; one group of power or switch, loop control device is assembled between two half beds as relay of massage mattress, so that this two groups of half beds massage mattress can massage your body independently and simultaneously or continuously; so, this full bed massage mattress with idler wheel can be folded from the middle section, it thereby can occupy less room and convenient to carry with.

### BACKGROUND OF THE INVENTION

1) Field of the Invention

This invention relates to folding bed massage mattress with idler wheel, which is composed of two groups of folding half bed mattresses, an independent motor-driven active shaft lever is mounted respectively in the inner middle section of mattress, each carry one group to mount on shaft lever, passive massage seat with idler wheel that can move to and fro in axial direction is installed on shaft lever; one group of power or switch, loop control device is assembled between two half beds as relay of massage mattress, so that this two groups of half beds massage mattress can massage your body independently and simultaneously or continuously.

2) Description of the Prior Art

Usually, full bed massage mattress is used for users to lie down and sleep, so that massage modules can knead, pinch or beat your back, or even below your waist and leg as human's hands; however, the traditional massage mattress which is assembled with single bed or smaller bed, the chair back mat or cushion-extended massage modules arranged can massage your body as required, or from head & neck downward waist and leg, then massage in cycle. Such full bed design, because it is comfort for people to lie down and easy to massage your body thoroughly in cycle, especially it isn't necessary to combine with chair, so, its production cost or weight has advantage over the traditional seating or lying massage chair.

However, such full bed massage mattress, its successive fitted massage modules are slightly shorter than bed that are driven by single driven device, it cannot shrink due to the bracket supporting vertical replacement structure; so, it may occupy more room when not use and also not easy to move, thereby, these disadvantages are required to get improved.

According to the patent with application No. 88215262 of R.O.C, the massage bed, wherein pivot joint (please refer to the structure sketch map of FIG. 4-A, marked by 22) is set at middle section of track (Marked by 20 in the drawing) used for massage modules to move to and fro, so that whole mattress can be folded and its size is also shrunk accordingly (please refer to the application sketch map of FIG. 4-B). However, its massage modules can not move smoothly when it extends out again after its track is dismantled for folding, further more, it is difficult to manufacture long track and ensure precision of pivot joint. The external covered structure of this full bed cover may affect pivot joint of track when folding, so, it can not be completely folded as described in the drawing, therefore, its structure is not practical.

### SUMMARY OF THE INVENTION

This invention is to provide folding full bed massage mattress with idler wheel, which is comprised by two half covered bed mattresses and connected with top of each mattress so that it can be folded; wherein an independent motor-driven active shaft lever is respectively mounted in inner middle section of this two groups of half bed mattresses, each carry one group to mount on shaft lever, passive massage seat with idler wheel that can move to and fro in axial direction is installed; one group of power or switch, loop control device is assembled between two half beds as relay of massage mattress, so that this two groups of half beds massage mattress can massage your body independently and simultaneously or continuously; so, this full bed massage mattress with idler wheel can be folded from the middle section, it thereby may occupy less room and convenient to carry with.

### BRIEF DESCRIPTION OF THE DRAWINGS

FIG. 1 is the exploded view of this invention in outspread.

FIG. 2 is the section view of this invention in outspread.

FIG. 2-A is the section view of this invention in folding.

FIG. 3-A is one of section view of half bed massage operation of this invention.

FIG. 3-B is another section view of half bed massage operation of this invention.

FIG. 3-C is the section view of full bed massage operation of this invention.

FIG. 3-D is the section view of full bed circulation massage operation of this invention.

FIG. 4-A is the structure description drawing of patent No. 88215262 of R.O.C.

FIG. 4-B is the application description drawing of patent No. 88215262 of R.O.C.

### DETAILED DESCRIPTION OF THE PREFERRED EMBODIMENTS

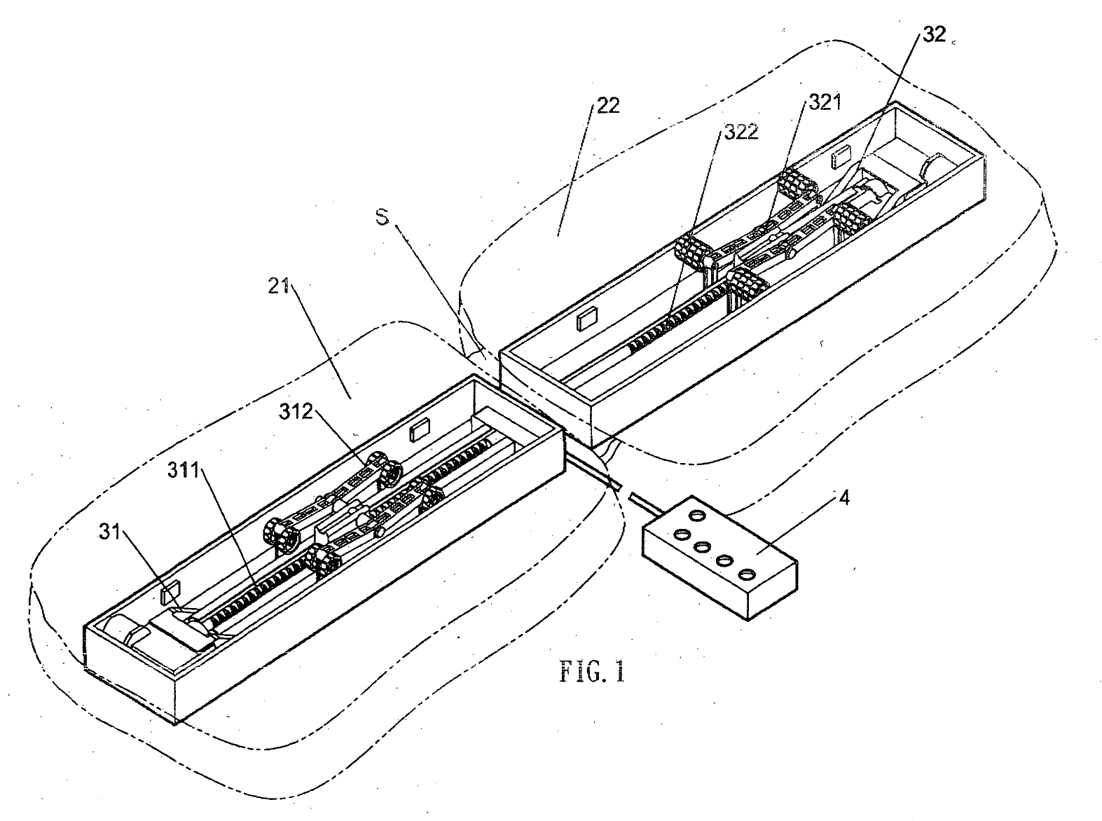

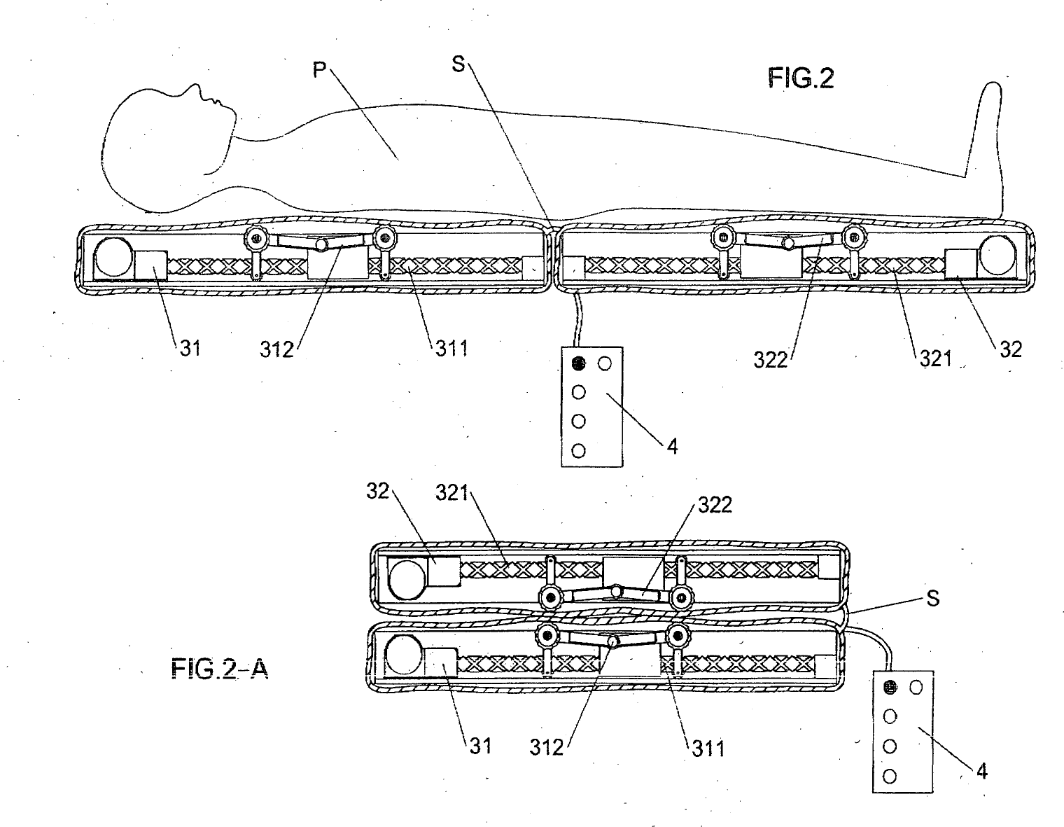

For your better reference, the execution and examples of this invention are hereby specially described with figures in the following. Please first refer to FIG. 1 and FIG. 2. The invention is comprised by two half bed mattresses 21,22, which is covered with mattress, as the two pieces of mattress are connected into full bed with joint S, so that the two half bed mattress 21,22 can be enfolded (as shown in FIG. 2-A); its features are as follows:

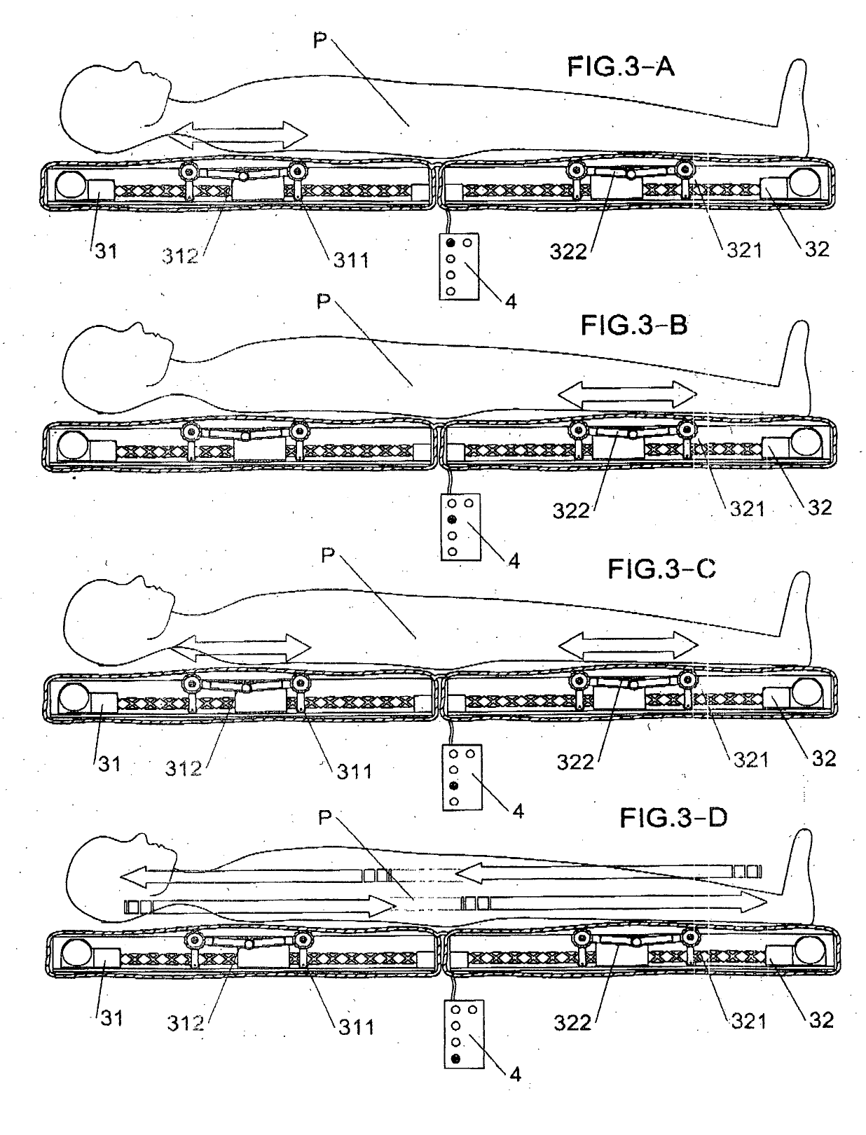

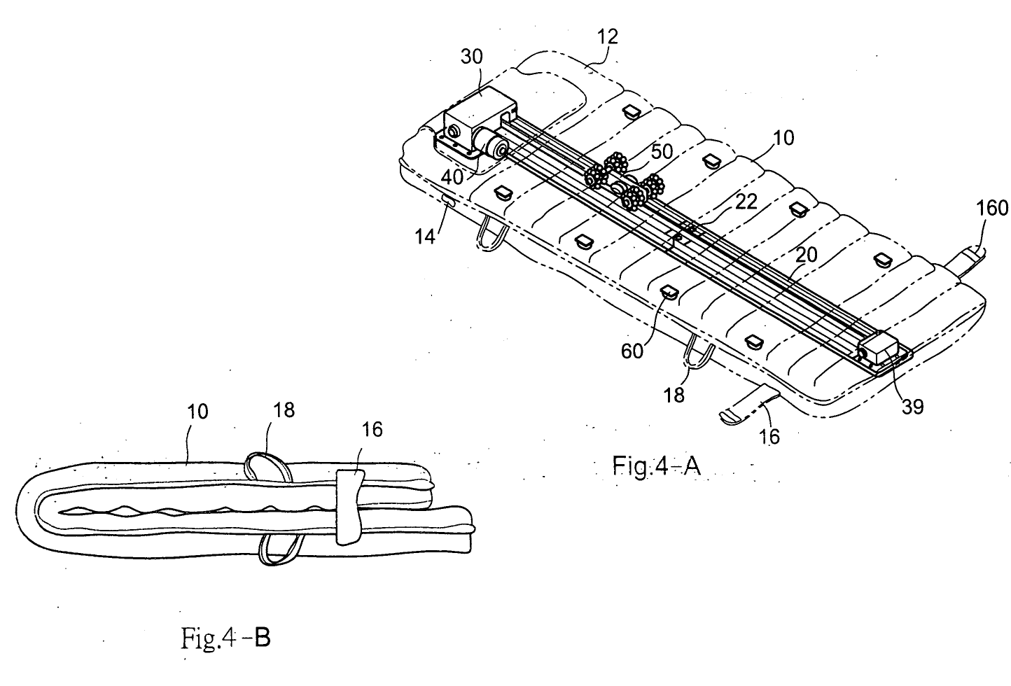

An independent motor-driven active shaft lever 311,321 is respectively mounted in inner middle section of half bed mattress 21,22, each carry one group to mount on shaft lever, so that passive idler wheel massage seat 312,322 with massage device 31,32 that can move to and fro in axial direction is installed; wherein one group of power or switch, loop control device 4 is assembled between two half beds as relay of massage mattress to drive the two groups massage device 31,32 to massage your body independently and simultaneously or continuously; so, user P lying on it can select and set easily with keys on control device 4.
1. Upper massage device 31 can solely massage body above waist (as shown in FIG. 3-A), or
2. Set lower massage device 32 to solely massage lower body (as shown in FIG. 3-B), or
3. Set upper and lower massage device 31, 32 to massage whole body (as shown in FIG. 3-C), or
4. Set idler wheel massage seat 312 of upper mattress 21 to move downward and stop running.

as near lower mattress 22, and idler wheel massage seat 322 of lower massage device 32 continues to move downward; as idler wheel massage seat 322 is pushed toward bottom, then return to move upward and stop when near upper mattress 21; idler wheel massage seat 312 of massage device 31 then continues to move upward; as idler wheel massage seat 312 is pushed toward top and return to move downward; basing on the continuous operation of these two idler wheel massage seat 311,312, your body can be massaged thoroughly in cycle (as shown in FIG. 3-D).

The two half bed mattresses 21, 22 are connected with joint S into full bed mattress, the independent massage device 31,32 is respectively mounted in inner middle section of the two groups of half bed mattress 21,22, so, the two groups of half bed mattress 21 and 22 can be enfolded when no use (as shown in FIG. 2-A), which may not damage or impact its structure; therefore, its cubage can be shrunk and easy to carry with. This is the purpose and effect of the invention.

What is claimed is:

1. A folding full bed massage mattress with idler wheel, which is comprised by two half covered bed mattresses and connected with top section of each mattress into full bed so that it can be folded; its features are as follows: an independent motor-driven active shaft lever is respectively mounted in inner middle section of this two groups of half bed mattresses, each carry one group to mount on shaft lever, passive massage seat with idler wheel that can move to and fro in axial direction is installed; one group of power or switch, loop control device is assembled between two half beds as relay of massage mattress, so that this two groups of half beds massage mattress can massage your body independently and simultaneously or continuously; so, this full bed massage mattress with idler wheel can be folded from the middle section, it thereby can occupy less room and convenient to carry with and transport.
